(19) United States
(12) Patent Application Publication
(10) Pub. No.: US 2010/0186652 A1
(43) Pub. Date: Jul. 29, 2010

(54) VESSEL MOORING MONITOR

(76) Inventor: Daniel Gary Martin, London (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/596,515

(22) PCT Filed: Apr. 21, 2008
(86) PCT No.: PCT/GB2008/050277

§ 371 Date: Mar. 22, 2010

(30) Foreign Application Priority Data
Apr. 19, 2007 (GB) 0707603.7

(51) Int. Cl. B63B 21/00; G01C 21/00

(52) U.S. Cl. 114/230.1

(57) ABSTRACT

A method and apparatus for monitoring for damage to or failure of a mooring system comprising mooring lines (2) or anchors of a moored vessel (1). The vessel has a mooring point (4) to which at least one mooring line is connected. The method involves determining the geographical position of a locating point (5) on the vessel remote from the mooring point (4) and determining the heading of the vessel. The geographical position of the mooring point (4) is then calculated from the determined position of the locating point and the vessel heading. The position of the mooring point (4) is compared to at least one expected position of the mooring point (4), in order to provide an indication of failure of a mooring line (2) or anchor. The method has the advantage that failure of the mooring (lines 2) or anchors can be detected without direct monitoring of the integrity of the mooring lines (2), which is typically expensive and uses equipment that is vulnerable to damage.

### FIELD OF THE INVENTION

This invention relates to a method and apparatus for monitoring failure in one or more of the mooring lines of a moored vessel or significant movement of their anchoring points on the seabed.

### BACKGROUND TO THE INVENTION

In the field of offshore oil and gas production, a moored vessel may be used as a floating production unit (FPU). Sometimes storage and offloading of product is performed from the same vessel (FPSO) and sometimes a separate vessel is used for storage and offtake (FSO). In the latter case, the production may be performed either on a platform or on a separate vessel. The vessels themselves are often converted oil tankers. FPU's, FPSO's, and FSO's are referred to hereinafter as FPSO's regardless of their exact function. The FPSO provides a repository for produced oil (or gas liquids) until there is a sufficient amount to offload into an offtake tanker that can be loaded completely and without delay. Typically, an FPSO is moored to the sea bed by means of multiple mooring lines attached to anchors, which may typically be pile anchors, suction anchors, or self-burying anchors of conventional type and which maintain the FPSO in a desired location. It is vitally important that the mooring system is monitored in order to determine whether a line has been damaged, come loose from its anchoring point on the sea bed, or if the anchoring points have moved. If a single mooring line or its anchoring point is damaged in this way, the effect on the position of the FPSO may not be particularly noticeable, but such damage must be recognised early in order that remedial action can be taken before further damage may allow the FPSO to break free from its moorings.

Typically, the mooring lines for an FPSO are connected to a mooring “turret” connected to the FPSO and about which the FPSO is able to rotate. Currently, the integrity of the mooring lines is monitored by measuring the angle of the mooring line at the mooring turret in order to provide an indication of the tension in the mooring line. If the angle drops below a predetermined level, it is inferred that the mooring line has gone slack due to damage. Such monitoring systems are expensive, complicated to install and maintain, and vulnerable to damage.

It would be desirable to provide a system for monitoring for damage to the mooring lines or anchoring points of an FPSO, or similar moored vessel, that is simpler to install and operate than known systems.

### SUMMARY OF THE INVENTION

Accordingly, this invention provides a method of monitoring for damage in the mooring lines or anchoring points (hereinafter called the mooring system) of a moored vessel having a mooring point to which at least one mooring line is connected, the method comprising the steps of:
i) determining the geographical position of a locating point on the vessel remote from the mooring point;
ii) determining the heading of the vessel;
iii) calculating the geographical position of the mooring point from the determined position of the locating point and the vessel heading;
iv) comparing the position of the mooring point to at least one expected position of the mooring point, in order to provide an indication of damage to a mooring line or its anchoring point.

Thus, according to the invention, damage to a mooring system can be determined by identifying the deviation of the geographical position of the mooring point from an expected position of the mooring point. In order for the method to be most effective, the position of the mooring point should be measured very accurately, for which sensitive measuring equipment is desirable. Unfortunately, locating sensitive measuring equipment at the mooring point of the vessel risks damage to the equipment, as there will often be relative movement of the vessel and the mooring system. The invention addresses this problem by determining the geographical location of a point on the vessel remote from the mooring point and calculating the location of the mooring point by reference to the location of the locating point and the heading of the vessel. In this way, the sensitive locating equipment may be positioned at a point on the vessel, for example on the bridge or in a control room, where the likelihood of damage is vastly reduced. By accurately monitoring the position of the mooring point, damage to the mooring system can be identified simply and without the complex monitoring equipment of the prior art.

The invention is of particular application to FPSO's or similar vessels. Typically, therefore, the vessel is normally permanently moored, i.e. a vessel intended to carry out its function generally at the same location over an extended period of time. This is as opposed to a transportation vessel, such as a ship, that is moored temporarily between voyages. It is often unnecessary for a permanently-moored vessel, such as an FPSO, to determine accurately it's heading, as it is not intended for travel or transportation.

Typically, the geographical location of the locating point is determined by means of satellite positioning such as by use of the Global Positioning System (GPS). Advantageously, the heading of the vessel may also be determined using GPS. For example, two spaced GPS antennas may be positioned at fixed locations on the vessel in order that the difference in their positions may be used to determine the heading of the vessel. Of course, the heading of the vessel may be determined by other means, such as a gyroscope or the like, although such devices are typically more expensive than a GPS solution for the same level of accuracy.

The invention may include the step of recording the geographical position of the mooring point over time in order to compile a set of expected positions of the mooring point. In this way, a set of “normal” positions of the mooring point over time may be compiled. Any significant deviation of the position of the mooring point from the set of expected positions may be taken to indicate damage to a mooring system. Without damage to the mooring system the vessel and the mooring point typically move their position due to tides, currents, winds and other environmental factors.

The comparison of the position of the mooring point to the expected position(s) may include measuring the period of time for which the mooring point has deviated from the expected position. Alternatively, or in addition, the comparison of the position of the mooring point to the expected position(s) may include measuring the excursion of the mooring point from the expected position. Furthermore, the comparison of the position of the mooring point to the expected position(s) may include determining the distance of the mooring point from the anchor points of the mooring lines, in order to determine that a mooring system has been damaged.

The invention extends to apparatus for monitoring for damage in the mooring system of a moored vessel having a mooring point to which at least one mooring line is connected, the apparatus comprising a satellite positioning device, at least one further device capable of determining a heading of the vessel, and a data processing device configured to:
i) determine the geographical position of a locating point on the vessel from the satellite positioning device;
ii) determine the heading of the vessel from the further device;
iii) calculate the geographical position of the mooring point from the determined position of the locating point and the vessel heading;
iv) compare the position of the mooring point to at least one expected position of the mooring point, in order to output an indication of damage to the mooring system.

The further device may be, for example, a gyroscope or a further satellite positioning device for positioning in a known spaced relationship to the first satellite positioning device.

In order for damage to a mooring line to be detected accurately in accordance with the invention, it is desirable for the heading to be determined with an accuracy of less than ±0.2 degrees×secLat RMS, preferably less than ±0.1 degrees×secLat RMS, and more preferably less than ±0.08 degrees×secLat RMS.

The method of the invention may include the step of calculating a value for the tension in at least one of the mooring lines. Thus, by determining the geographical position of the mooring point on the vessel, and knowing the position of the mooring line anchor (or at least that the anchor has not moved), a value for the tension in the mooring line can be calculated. This value need not be perfectly accurate, provided that it is a reasonable indication to the operator of the expected tension level in the mooring line. By calculating the tension, one can compare the result to a range of predetermined acceptable tensions and identify any deviations from the acceptable tensions. This can be used to identify if a mooring point has moved or if a mooring line is broken.

This in itself is believed to be novel, and thus viewed from a further aspect, the invention provides a method of monitoring the tension in a mooring line of a moored vessel having a mooring point to which the mooring line is connected, the method comprising the steps of:
i) determining the geographical position of the mooring point;
ii) using the determined geographical position of the mooring point relative to a known geographical reference position to calculate a value for the tension in the mooring line.

The known geographical reference position may be the position of an anchor connected to the mooring line. Alternatively, the known geographical position may be a known position of the mooring point associated with a known tension in the mooring line. The geographical position of the mooring point(s) can be determined in any suitable manner, for example by means of a satellite positioning system.

### BRIEF DESCRIPTION OF THE DRAWINGS

An embodiment of the invention will now be described by way of example only and with reference to the accompanying drawings, in which:

FIG. 1 is a view of an FPSO with a spread mooring pattern utilising an embodiment of the invention;

FIG. 2 is a view of an FPSO with a turret mooring utilising an embodiment of the invention; and

FIG. 3 is a schematic representation of a statistical distribution of the position of a mooring point of the FPSO of FIG. 2.

### DETAILED DESCRIPTION OF AN EMBODIMENT

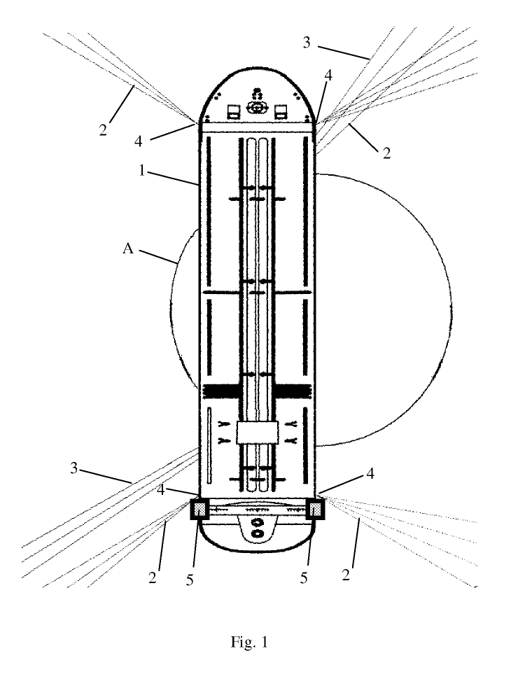

FIG. 1 shows a Floating Production Storage and Offloading Vessel (FPSO) 1 moored by a plurality of mooring lines 2 to sea bed anchors (not shown). The FPSO is also connected by pipelines 3, to oil wells, which supply oil to the FPSO 1 for storage. As represented in FIG. 1 by the circle A, the FPSO 1 will tend to move on its mooring lines 2 due to currents, tides, waves, wind, etc.

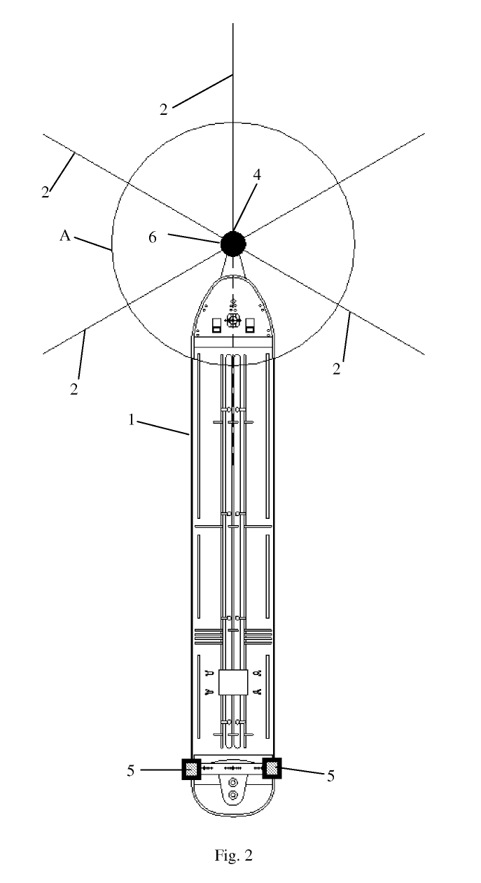

In FIG. 1, the FPSO is spread-moored in that the four sets of mooring lines 2 are each connected to respective mooring points 4 on the hull of the FPSO. In an alternative arrangement shown in FIG. 2 the FPSO may include a mooring turret 6 which includes the mooring points 4 to which the mooring lines 2 are connected. In this case, the FPSO can rotate (or “weather vane”) about the mooring turret 6 in order to face into the prevailing wind or current and therefore reduce stress on the mooring lines 2. The invention is suitable for use with spread-moored or turret-moored FPSOs with either internal (within the hull) or external (outside the hull) turrets.

An embodiment of the invention provides a self-contained electronic system to monitor the real-time position of the mooring points 4 of an FPSO and through a statistical probability algorithm compare the current position of the mooring points to their normal excursion envelope and generate an alarm if the mooring system deteriorates such that abnormal excursions are detected.

To monitor the real-time position of the mooring points 4 on the vessel 1 (or on the turret) this embodiment of the invention uses two GPS antennas 5 to determine both the position and heading of the vessel 1. The invention allows the GPS antennas 5 to be mounted at the stern of the vessel above the accommodation, as shown in FIGS. 1 and 2, rather than installing an antenna directly above the turret 6 or each mooring point 4. The system includes two state-of-the-art, 20 channel all-in-view GPS receivers, including L1/L2 GPS, L1/L2 GLONASS (Global Navigation Satellite System), and WAAS (Wide Area Augmentation System), where available. The heading of the vessel 1 is determined from the differential position of the two GPS antennas 5 which can typically provide a heading accuracy better than ±0.1 degrees, for example on an FPSO having a beam of 40 m.

After taking into account the combined error of the position and heading, the system provides the position of the mooring points 4 on the vessel (or turret) to an accuracy better than ±3.5 meters which is less than the observed change in position on the failure of one mooring line for most water depths. In very shallow water where the observed change in excursion is correspondingly smaller, an external differential reference may be supplied to generate a Differential Global Positioning System (DGPS) using Real-Time Kinetic (RTK) corrections to improve the position accuracy. With such an external reference the combined error is typically less than ±1.5 meters.

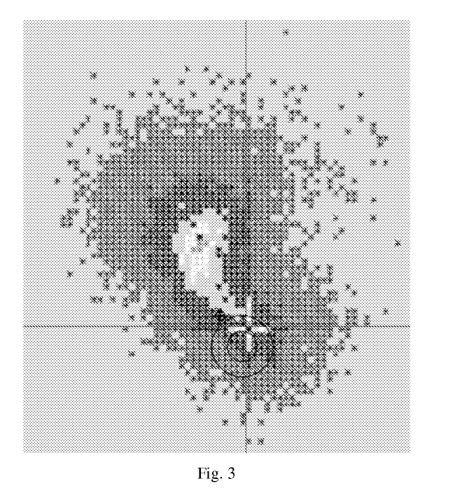

Three separate methods of determining mooring system failure are possible, and the system may be configured to use any or all methods. The first method is to detect if the excursion distance vector deviates from the average GPS position of each mooring point 4 by more than a preset threshold value. The second method is to detect if the excursion distance vector referenced to the nominal position of each mooring line anchor exceeds preset values. Typically, up to sixteen anchor lines could be monitored in this way. The third method is to monitor the time spent in excess of a preset value in a location that has a statistically low probability of occurrence. In this regard, the system is arranged to record the position of each mooring point 4 over time in order to build up a probability map for each position, as represented in FIG. 3.

Physically, the system consists of a base station unit (approx. 483×390×88 mm), two external GPS antennas 5, and a desk top PC computer used to provide a graphical user interface. The system hardware can be provided by the OSPREY DGPS tanker berthing system available from Ocean Technical Systems Limited of Cheam, Surrey, United Kingdom. The user interface includes a scaled real-time representation of the FPSO vessel 1 and a graphical representation of the excursion envelope of the FPSO. The operator display includes a graphical representation of the vessel superimposed on a marine chart with a dynamic image of each of the anchor lines. The position of a turret is shown with a vector drawn from the nominal position. A statistical probability distribution is displayed graphically around the turret based on its previously recorded movement, as shown in FIG. 3, typically using colour representation, a range of grey shades, or numbers on a scale representing probability.

In addition, to outputting the excursion envelope of the FPSO, the system can calculate a value for the tension in each of the mooring lines based on the current position of each of the mooring points 4 relative to their respective anchors. A continuous output for the tension in each mooring line may therefore be generated. It is known to calculate the tension in mooring lines during the design of offshore installations. Using the described system, however, the tension in the mooring lines may be calculated continuously.

The base station operates autonomously and typically includes a microprocessor, 160 GB hard drive, two DGPS receivers, six multi-protocol serial ports, and an 10/100 Mbit/s Ethernet port for connection to the operator's PC computer and includes the following interfaces:
i) NMEA (National Marine Electronics Association) -0183 Serial Port to input an alternative vessel heading from the existing vessel gyroscope (if available);
ii) NMEA-0183 Serial Port to input an alternative vessel position from the vessel DGPS system (if available);
iii) ASCII Serial Port to connect to an existing MET-OCEAN system to input wind and sea current speed/direction (if available);
iv) MODBUS RTU Serial Port to connect to an existing distributed control system (DCS) to output the common Mooring Line Failure Alarm (if available);
v) BINARY Serial Port to connect to a communication system (e.g. UHF radio) to input external RTK DGPS correction data (if available);
vi) NMEA-0183 Serial Port to output the derived vessel heading;
vii) NMEA-0183 Serial Port to output the derived vessel position; and
viii) 10/100 Mbit/s Ethernet Port (for connection to operator PC computer)

The system operates autonomously using internal dual GPS receivers to determine vessel position, heading and roll. To improve positional accuracy, the base station can interface with either an existing commercial DGPS service (±1.0 meter) or to an RTK DGPS reference (±0.02 meter) that is an integral part of the monitoring system. The system may also be connected to a MET-OCEAN system to obtain wind and sea current data and may be interfaced to an existing DCS (Distributed Control System) to provide a common alarm on mooring system failure. A NMEA-0183 output of vessel heading and position may be provided for use with third party instrumentation.

Comprehensive data logging to store both raw real-time data and calculated data permits correlation with external inputs such as wind speed/direction. The data is logged to the base station hard drive, which has sufficient capacity to provide typically in excess of five years continuous storage at 1 Hz sampling rate. The data can be logged in ASCII format to facilitate easy access, for example via third party software either manually or automatically via the Ethernet port. Data can be logged at a frequency of 1 Hz and include a time and date stamp for each entry to include vessel position, vessel heading, vessel roll, wind speed/direction, sea current speed/direction, excursion from nominal position, magnitude of error, and diagnostic flags.

In summary, there is described herein a method and apparatus for monitoring damage to mooring lines 2 or anchors of a moored vessel 1. The vessel has a mooring point 4 to which at least one mooring line is connected. The method involves determining the geographical position of a locating point 5 on the vessel remote from the mooring point 4 and determining the heading of the vessel. The geographical position of the mooring point 4 is then calculated from the determined position of the locating point and the vessel heading. The position of the mooring point 4 is compared to at least one expected position of the mooring point 4, in order to provide an indication of damage to a mooring line 2 or anchor. The method has the advantage that failure of the mooring lines 2 can be detected without direct monitoring of the integrity of the mooring lines 2, which is typically expensive and vulnerable.

1. A method of monitoring for failure in the mooring system comprising the mooring line and anchor of a moored vessel having a mooring point to which at least one mooring line is connected, the method comprising the steps of:
i) determining the geographical position of a locating point on the vessel remote from the mooring point;
ii) determining the heading of the vessel;
iii) calculating the geographical position of the mooring point from the determined position of the locating point and the vessel heading;
iv) comparing the position of the mooring point to at least one expected position of the mooring point, in order to provide an indication of failure of a mooring line or anchor.

2. A method as claimed in claim 1, wherein the vessel is a permanently moored vessel.

3. A method as claimed in claim 1, wherein the geographical location of the locating point is determined by means of a satellite positioning system.

4. A method as claimed in claim 1, wherein the heading of the vessel is determined using two spaced satellite positioning antennas positioned at fixed locations on the vessel.

5. A method as claimed in claim 1, wherein the method includes the step of recording the geographical position of the mooring point over time in order to compile a set of expected positions of the mooring point.

6. A method as claimed in claim 1, wherein the comparison of the position of the mooring point to the expected position(s) includes measuring the excursion of the mooring point from the expected position.

7. A method as claimed in claim 1, wherein the comparison of the position of the mooring point to the expected position(s) includes measuring the period of time for which the mooring point has deviated from the expected position(s).

8. A method as claimed in claim 1, wherein the comparison of the position of the mooring point to the expected position(s) includes determining the distance of the mooring point from the anchor points of the mooring lines.

9. A method as claimed in claim 1, wherein the method includes the step of calculating a value for the tension in at least one of the mooring lines.

10. A method of monitoring the tension in a mooring line of a moored vessel having a mooring point to which the mooring line is connected, the method comprising the steps of:
i) determining the geographical position of the mooring point;
ii) using the determined geographical position of the mooring point relative to a known geographical reference position to calculate a value for the tension in the mooring line.

11. A method as claimed in claim 10, wherein the known geographical reference position is the position of an anchor connected to the mooring line.

12. Data processing apparatus adapted to carry out the method of claim 1.

13. Computer software which configures general purpose data processing apparatus to carry out the method of claim 1.

14. Apparatus for monitoring for failure in the mooring lines or anchor of a moored vessel having a mooring point to which at least one mooring lines is connected, the apparatus comprising a satellite positioning device, at least one further device capable of determining a heading of the vessel, and a data processing device configured to
i) determine the geographical position of a locating point on the vessel from the satellite positioning device,
ii) determine the heading of the vessel from the further device,
iii) calculate the geographical position of the mooring point from the determined position of the locating point and the vessel heading, and
iv) compare the position of the mooring point to at least one expected position of the mooring point, in order to output an indication of failure of a mooring line or anchor.
